(19) United States
(12) Patent Application Publication
(10) Pub. No.: US 2004/0236582 A1
(43) Pub. Date: Nov. 25, 2004

(54) Server apparatus and a data communications system

(75) Inventors: Tadashi Yoshikai, Fukuoka-shi (JP); Toshiyuki Kihara, Munakata-gun (JP); Yoshiyuki Watanabe, Kasuya-gun (JP); Hisashi Koga, Fukuoka-shi (JP); Yuji Arima, Ogouri-shi (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 10/844,462

(22) Filed: May 13, 2004

(30) Foreign Application Priority Data
May 22, 2003 (JP) 2003-144476

(51) Int. Cl. G10L 21/00

(52) U.S. Cl. 704/278; 704/270

(57) ABSTRACT

The invention aims at providing server apparatus capable of outputting image data and sound data thereby deactivating sound transmission at a low cost and with ease. That is, a sound input device (microphone) for converting sound to a sound signal is made detachable. A connection detector for detecting whether this sound input device (microphone) is connected is provided. In case the sound input device is connected to a sound input section, the sound transmission function is automatically controlled into the operating state. In case the sound input device is not connected, the sound transmission function is automatically controlled into the non-operating state. Thus, only a simple procedure of removing the sound input device from the sound input section is needed to deactivate sound transmission. This allows switching between activation and deactivation of sound transmission at a low cost.

Useless sound data (null data) is not transmitted when the sound input device is not connected. This allows efficient use of communications lines.

### BACKGROUND OF THE INVENTION

1. Field of the Invention

The present invention relates to server apparatus and a data communications system.

2. Description of the related art

A technology which uses a transmitter terminal equipped with a camera and a microphone to transmit sound together with an image to a receiver terminal via a network is described in the Japanese Patent Laid-Open No. 247637/1997. This technology changes the orientation of the microphone in case orientation of the camera is changed by way of remote operation. This technology provides a sense of harmony between image information and sound information so as to provide a realistic system.

Depending on the imaging situation, a person who manages a camera (hereinafter referred to as a camera manager) sometimes wishes to transmit an image but not sound. In this case, sound transmission must be deactivated by some means. In case the microphone is a built-in microphone housed in a transmitter terminal, a mechanical switch must be installed in order to deactivate sound transmission, which leads an increase in the cost of the transmitter terminal. In case deactivation of sound transmission from the transmitter terminal is to be deactivated on a computer connected to a network, extra time is required to power on and start up the computer. Moreover, connecting the computer via cumbersome operation requires additional time and workload.

Thus in the prior art, deactivation of sound transmission cannot be performed at a low cost and with ease.

### SUMMARY OF THE INVENTION

In view of the problems, the invention aims at deactivating sound transmission at a low cost and with ease. That is, the invention provides server apparatus capable of outputting image data and sound data via a network in response to a request made by a client terminal, the server apparatus comprising: a sound input section to which a sound input device to convert sound to a sound signal is connectable; a sound processor connected to the sound input section, the sound processor converting the sound signal to sound data; a sound output section which transmits the sound data to the client terminal via the network; and a connection detector which detects whether the sound input device is connected to the sound input section. Based on the information from the connection detector, the sound output section is controlled into the operating state. In case the sound input device is connected, the sound output section is automatically controlled into the operating state. In case the sound input device is not connected, the sound output section is automatically controlled into the non-operating state. Thus, simply removing the sound input device from the sound input section can halt sound transmission, thereby switching activation/deactivation of sound transmission at a low cost while avoiding transmission of unwanted sound data when the sound input device is not connected. This reduces the communications data volume thus providing efficient use of communications lines.

A storage section for storing setting information on whether to activate the sound output section is provided in the server apparatus. It is thus possible to store setting information irrespective of the connection/disconnection of the sound input device, thereby freely setting transmission of sound data.

In case the setting information stored in the storage section specifies deactivation of the sound output section, that setting is given priority and the sound input device does not operate and inhibits transmission of sound data even in case an externally connected microphone is connected.

A controller transmits information including a command to request transmission of display information and a sound processing program to a client terminal in response to an access from the client terminal. As a result, the client terminal can perform processing smoothly by using the information including a transmission request command.

Display control means for controlling the display of the client terminal to display the information that sound output is unavailable in case a response indicating that a microphone is not connected from server apparatus is received by the client terminal or sound data cannot be transmitted from the server apparatus to the client terminal. This allows easy and secure determination on whether sound data reception is possible.

A computer available as a client terminal comprises display control means which controls the display to provide the information that sound output is unavailable on a response from the server apparatus that sound data cannot be transmitted. This allows easy and secure determination on whether sound data reception is possible. The computer further comprises display control means which controls the display to provide the information that sound output is unavailable in case a command to request sound data from the server apparatus is transmitted to the server apparatus via a network and a predetermined time has elapsed without receiving sound data. This allows easy and secure determination on whether sound data reception is possible even in case firewall is present.

The computer available as a client terminal comprises: sound data control means for controlling a sound buffer to store sound data received from the server apparatus; sound output means for outputting the sound data stored in the sound buffer to a sound regenerator; and sound buffer control means for changing the capacity of the sound buffer. This allows the sound data reception state flexibly in accordance with the communications environment.

### BRIEF DESCRIPTION OF THE DRAWINGS

FIG. 1 is a block diagram of a network camera system in Embodiment 1 of the invention;

FIG. 2 is a block diagram of a network camera in Embodiment 1 of the invention;

FIG. 3 is a time chart of sound output operation in Embodiment 1 of the invention;

FIG. 4 shows a screen display of the display of the client terminal in Embodiment 1 of the invention;

FIG. 5 is a first control flowchart of a network camera in Embodiment 1 of the invention;

FIG. 6 is a second control flowchart of a network camera in Embodiment 1 of the invention;

FIG. 7 is a first control flowchart of a client terminal camera in Embodiment 1 of the invention;

FIG. 8 is a second control flowchart of a client terminal camera in Embodiment 1 of the invention;

FIG. 9 is a third control flowchart of a client terminal camera in Embodiment 1 of the invention; and

FIG. 10 is an external view of the network camera in Embodiment 1 of the invention with a microphone installed.

### DESCRIPTION OF THE PREFERRED EMBODIMENTS

(Embodiment 1)

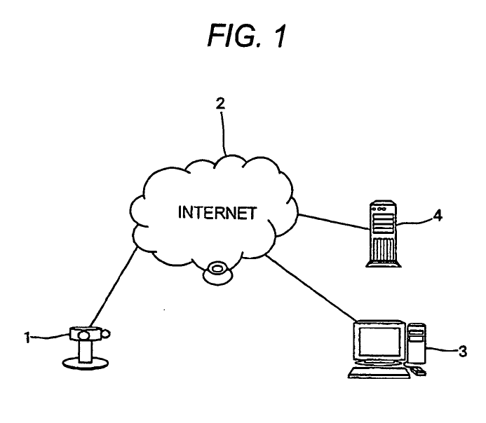

Described below are a network camera as an embodiment of the server apparatus of the invention and a network camera system (data communications system of the invention) where the network camera is connected to a network such as the Internet to allow an access from an external terminal. In FIG. 1, a numeral 1 represents a network camera server apparatus of the invention), 2 the Internet (network of the invention), 3 a client terminal such as a computer communicable while connected to the Internet 2, and 4 a DNS server. The network camera 1 comprises a camera mentioned later and to which a microphone can be connected as required.

In the network camera system, image/sound shot or collected by the network camera 1 is transmitted to the client terminal 3 via the Internet 2. The DNS server 4 performs conversion such as conversion of an IP address and a domain name.

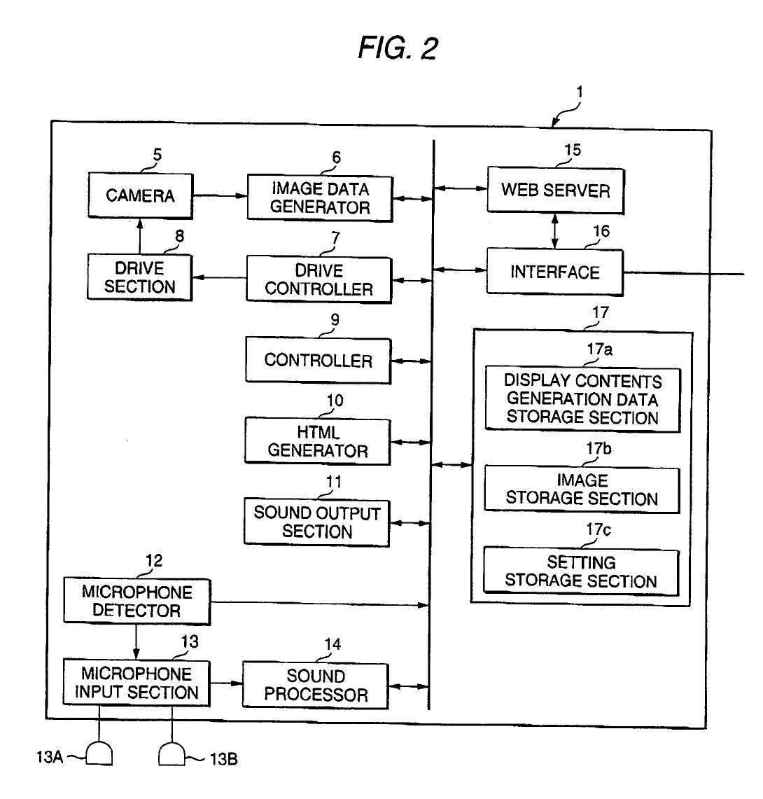

Next the network camera will be detailed. FIG. 2 is a block diagram of the network camera 1. In FIG. 2, a numeral 5 represents a camera, 6 an image generator, 7 a drive controller, 8 a drive section such as a motor, 9 a controller, 10 an HTML generator, 11 a sound output section, 12 a microphone detector (connection detector of the invention), 13 a microphone input section (sound input section of the invention), 13A, 13B microphones for external connection (sound input device of the invention), and 14 a sound processor.

In Embodiment 1, the external network connected is the Internet. As a network server, a web server 15 which performs communications by way of the protocol HTTP is provided. The HTML generator 10 generates a web page described in HTML as data for generating display contents. A numeral 16 represents an interface for performing communications control of a lower layer in order to connect to an external network.

A numeral 17 represents a storage section, 17a display contents generation data storage section, 17b an image storage section, and 17c a setting storage section. The data for generating display contents is data described in a markup language in order to display information on the hyperlinked network using a browser and described hereinafter as a web page. In case it is described in another language, the data serves as data for generating display contents described in that language.

Two microphones 13A, 13B are an example in Embodiment 1 and the number of microphones is not limited thereto.

The network camera 1 of Embodiment 1 converts an image shot with the camera 5 to image data on the image data generator 6. On receiving a request from a browser, the network camera 1 transmits the image data from the image storage section 17b to the client terminal 3 via the web server 15, the network camera 16 and the Internet 2. The network camera 15 transmits the image data by using the protocol HTTP via the Internet 2. The network camera 16 performs communications control of a lower layer.

The camera 6 changes its imaging field while being driven vertically and horizontally and driven so that the imaging field will expand or contract. The drive section 8 is controlled by the drive-controller 7. The drive controller 7 can control the drive speed of the drive section 8.

The microphone input section 13 comprises one or more connection terminals to which connection pins of the microphone 13A or microphone 13B can be connected. The microphone detector 12 comprises a hardware circuit. In case at least one microphone 13A or 13B is connected, the microphone detector 12 outputs a HIGH level signal. In case no microphones 13A, 13B are connected, the microphone detector 12 outputs a LOW level signal With this, it is possible to detect whether either the microphone 13A or 13B are connected to the microphone detector 12.

The sound processor 14 processes the sound signal collected by the microphones 13A, 13B and outputs sound data in the form of a digital signal. In other words, the sound processor 14 amplifies the sound signal input from the microphones 13A, 13B and A/D converts the resulting signal to obtain corresponding data. In case the controller 9 has determined that both microphones 13A, 13B are connected to the microphone input section 13, the sound processor 14 processes the sound data from the microphones 13A, 13B as a stereo sound signal.

The sound output section 11 transfers the sound data obtained through conversion by the sound processor 14 to the network camera 15 as well as transmits the data to the external client terminal 3 via the network camera 16 and the Internet 2.

The HTML generator 10 generates a web page to be transmitted to outside. On an access from the client terminal 3, the web page generated by the HTML generator 10 is displayed on the screen of the xxx 4. Markup languages which describe data for generating display contents include HTML as well as MML, HDTL, and WML. Any language may be employed.

The storage section 17 comprises a RAM, a hard disk and other storage media. The storage section 17 includes a display contents generation data storage section 17a, an image storage section 17b, and a setting storage section 17c. The display contents generation data storage section 17a stores data for generating display contents. The image storage section 17b stores image data generated by the image data generator 6.

The controller 9 serves as function means by reading a program into a Central Processing Unit (hereinafter referred to as CPU) and controls the entire network camera 1 in a centralized fashion. The web server 15 may be separately provided from the controller 9 or may be implemented by the controller 9.

The controller 9 performs control of the microphones 13A, 13B: The controller 9, on receiving a HIGH level signal from the microphone detector 12, determines that at least one of the microphones 13A and 13B is connected to the microphone input section 13. The controller 9 then controls the sound output section 11 into the operating state to allow transmission of sound data. On a request for sound output from an external client terminal 3 while the sound output section 11 is operating, the sound output section 11 transmits sound data to the client terminal 3. The microphone detector 12 may output a connection detecting signal from each of the microphones 13A, 13B to the controller 9.

On receiving a LOW level signal from the microphone detector 12, the controller 9 determines that neither the microphone 13A nor microphone 13B is connected to the microphone input section 13. The controller 9 then controls the sound output section 11 into the non-operating state even in case a request for sound output is issued from the client terminal 3. In other words, the controller 9 controls transmission of sound data from the sound output section 11 based on the result of detection of a microphone 13A, 13B by the microphone detector 12. As a result, the client terminal 3 can check whether an external microphone is connected to the network camera 1 via the Internet 2. Checkup of connection of the external-connection microphone 13A, 13B is described below.

There are at least two methods for an external client terminal 3 to check whether the external-connection microphone 13A, 13B is connected to the network camera 1. A first method is an inquiry method where the client terminal 3 makes an inquiry to the network camera 1 via the Internet 2. A second method is a receiving state determination method where the client terminal 3 determines connection of a microphone from the state of sound data reception from the network camera 1. In the network system according to Embodiment 1, any of these methods is available.

The first “inquiry” method will be described. In this method, in response to an inquiry about the presence of the microphone 13A, 13B from the client terminal 3, the network camera 1 communicates the result of determination on the presence of the microphone 13A, 13B to the client terminal 3 via the Internet 2. On receiving an inquiry, the web server 15 communicates the determination result based on the information (flag) on the presence of the microphone 13A, 13B set by the controller 9 in accordance with the detection result from the microphone detector 12. Thus, it is possible to transmit the state of external connection of the microphone 13A, 13B without delay in response to an inquiry from the client terminal 3. A browser, receiving the notice, displays the determination result on the display of the client terminal 3. Thus the user of the client terminal 3 can readily check whether the external connection camera 13A, 13B is connected to the network camera 1. This inquiry method makes a direct inquiry from the client terminal 3 to the network camera 1 so that it is possible to advantageously check for connection of the external microphone 13A, 13B. On receiving a request for sound output from the client terminal 3 while the external microphone 13A, 13B is not connected to the network camera 1, the network camera 1 may directly transmit the state of external connection of the microphone 13A, 13B.

The second method or “receiving state determination method” will be described. In this method, in case the client terminal 3 does not receive sound data from the network camera 1 for a predetermined time, it is assumed that an external microphone is not connected to the network camera 1. In this case, a sound processing program (mentioned later) is plugged in to the client terminal 3, in which sound processing program is provided a detection function on reception of sound data.

The receiving state determination method is advantageous in that, even in case a notice from the network camera 1 is blocked by a firewall as defense means to prevent an illegal access and cannot received by the client terminal 3, the client terminal 3 can check for connection of an external camera to the network camera 1. For example, even when the network camera 1 notifies that the microphones 13A, 13B of the network camera 1 have been removed while the client terminal 3 is receiving sound data from the network camera 1, the notice may be guarded by the by a firewall, if any, and may not be recognized by the client terminal 3.

Even in such a situation, by providing a detection function on reception of sound data in a sound processing program (mentioned later) plugged in to the client terminal 3, it is detected that sound data is not received for a predetermined time at the client terminal 3. This allows the sound processing program to assume that the microphones 13A, 13B are removed and notifies the user of the client terminal 3 to the effect.

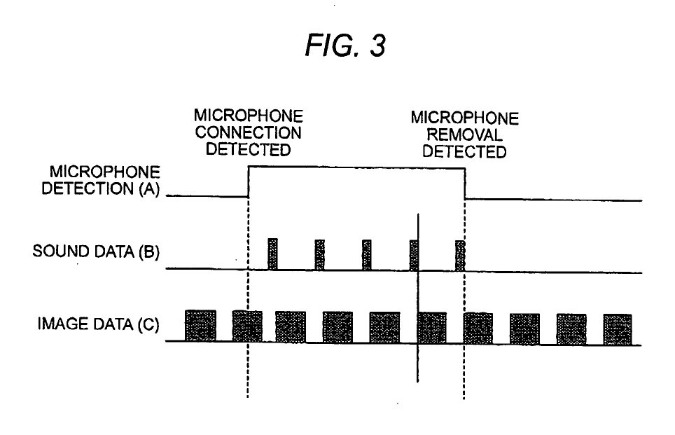

Next, sound output operation in the network camera system of Embodiment 1 of the invention will be described. FIG. 3 is a time chart of sound output operation in Embodiment 1 of the invention, where the vertical axis represents the volume of signal and the horizontal axis the time.

FIG. 3A is a mm detection time chart. As shown in FIG. 3A, in case the network camera 1 has detected connection of a microphone 13A, 13B to the microphone input section 12 by way of the microphone detector 12 and controller 9 (in case a microphone is present), the controller 9 controls the sound output section 11 into the operating state. In case the network camera 1 has not detected connection of a microphone 13A, 13B (in case a microphone is absent), the controller 9 controls the sound output section 11 into the non-operating state. FIG. 3B is a sound data time chart. FIG. 3B shows that sound data is output from the sound output section 11 at predetermined intervals and transmitted to the client terminal 3 only in case the sound output section 11 is in the operating state. FIG. 3C is an image data time chart. FIG. 3C shows that image data is generated in the image data generator 6 at predetermined intervals and transmitted to the client terminal 3 irrespective of the connection of the microphone 13A, 13B (presence of microphone). The image data maybe still picture data or moving picture data. While image data and sound data are transmitted separately in this example, the invention is not limited thereto but image data and sound data may be transmitted together in the data on a web page.

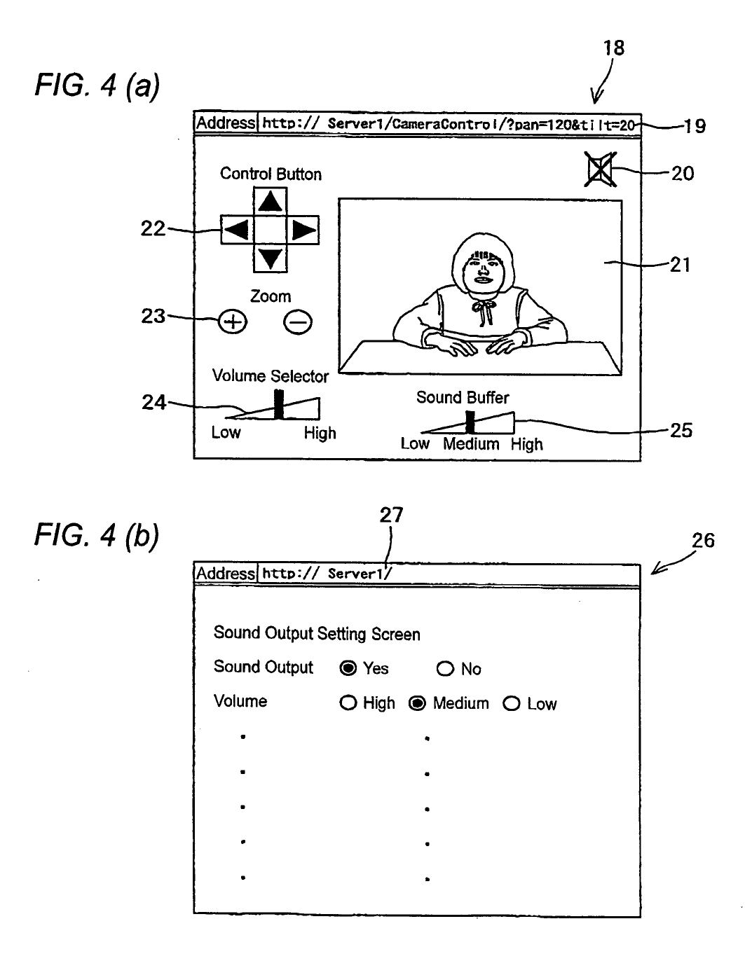

FIGS. 4A and 4B show the screens which appear on the display of the external client terminal 3 in response to an access to the network camera 1 from outside. FIG. 4A is a screen display in the normal operating state. A screen display 18 shows data such as data for generating display contents and image data transmitted from the network camera 1 on the display (not shown) of the client terminal 3 by way of the browser (not shown) on the client terminal 3. In the upper area 19 of the screen display 18 is shown the URL of the network camera 1. This URL is used to activate CGI for operation of the network camera 1 such as panning and tilting.

A sound regeneration unavailable indication 20 is shown when no sound data is received from the network camera 1. For example, in case the client terminal 3 transmitted a sound data request to the network camera 1 although the client terminal 3 has received from the network camera 1 a response that the microphone 13A, 13B is not connected, or in case the client terminal 3 cannot connect to the Internet 2 , or in case the client terminal 3 does not receive sound data for a predetermined time, the “X” mark of the sound regeneration unavailable indication 20 is displayed. With this indication, the user of the client terminal 3 knows that the sound input function of the network camera 1 is invalid so that the user can skip unnecessary procedures such as investigating the state of the sound regenerator (such as a loudspeaker, although not shown) of the client terminal 3. This provides a user-friendly operating environment.

On an image display 21 is displayed an image shot with the network camera 1. A control button 22 is used to change the shooting position (orientation) of the camera 5 and corresponds to the up/down and left/right operations. Pressing the control button 22 activates the drive controller of the network camera 1 and the camera 5 is operated. A zoom 23 is a button for scaling up or down the imaging field of the camera 5. Pressing the plus button causes the drive controller to enlarge the imaging field while pressing plus button causes the drive controller to contract the imaging field.

A volume selector 24 changes the volume of the sound received from the network camera 1. Thus, a client can change the volume of sound data transmitted. In this case, an amplifier at the client terminal 3 (sound amplifier built into the client terminal 3 which is not shown) is used to amplify the sound data.

While sound output operation is controlled by way of connection detection of the microphone 13A, 13B in the foregoing example, control of sound output operation maybe made otherwise. In Embodiment 1, sound output operation can be previously set on the network camera 1 or an external terminal. FIG. 4B shows screen display for sound setting. Only the user of the network camera 1 or the camera manager has a right to open this sound output setting screen 26 to set or change conditions. The camera manager can access the screen and set/change the conditions from the network camera 1 or a management terminal (not shown). The user of the network camera 1 accesses, on the browse of a single client terminal, the network camera 1 or URL of a server for setting (not shown) and input a password and an ID to display the sound output setting screen 26 for setting/changing the conditions on the screen.

The user or the camera manager sets whether to output sound by using radio buttons on the sound output setting screen 26. Further, the user or the camera manager can set the volume to three levels, high, medium and low by way of the volume switch on the sound output setting screen 26. This adjusts the volume of sound data the network camera 1 transmits to the client terminal 3. The volume may be also arbitrarily set in a stepless fashion.

The contents set on the sound output setting screen 26 in FIG. 4B is transmitted to the URL for storing setting information shown in its upper area 27, that is, to the setting storage section 17c of the network camera 1 and then stored therein.

Setting/Change on the sound output setting screen 26 is accepted irrespective of whether a microphone is connected. Setting is thus stored irrespective of whether a microphone is connected, which allows arbitrary setting concerning communications of sound data and setting/changing the current setting even when a microphone is not connected. This assures excellent usability. Conversely, even when the setting information is “sound output available”, an “Error” will not result when the external-connection microphone is removed and the sound regeneration unavailable indication 20 is displayed on the screen of the client terminal, which notifies the user of the client terminal of the current situation.

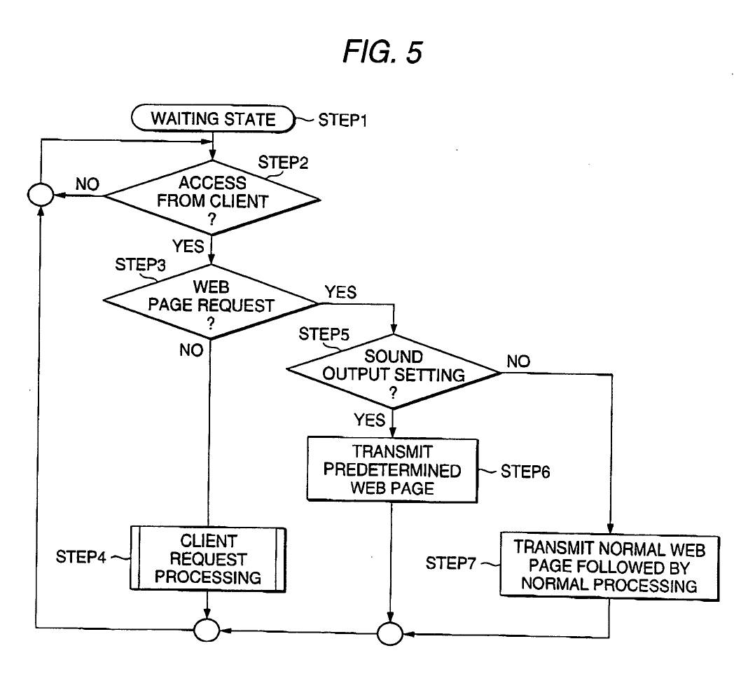

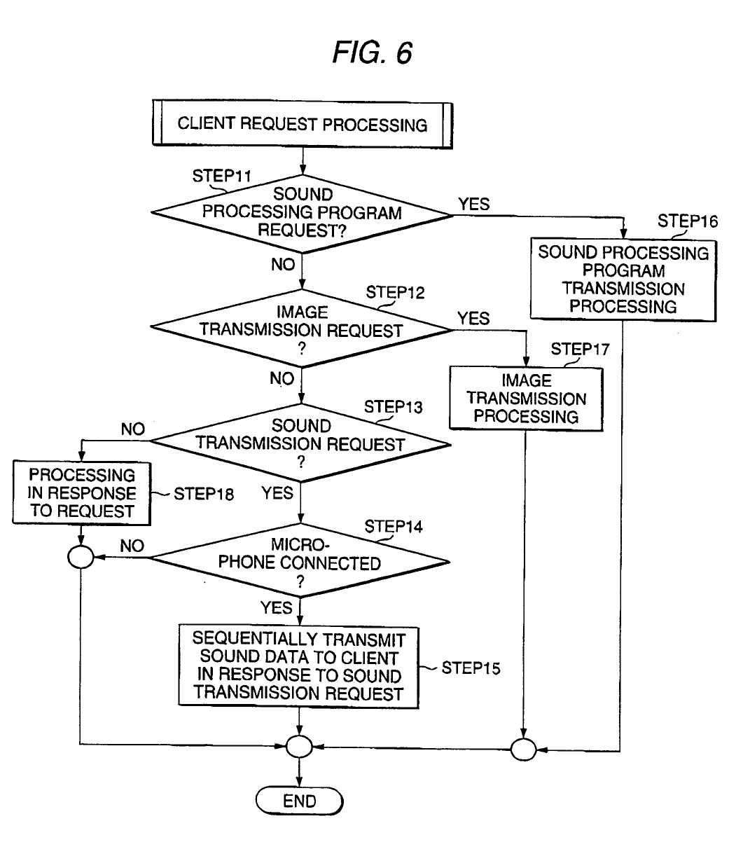

The control flow of the network camera 1 is described below referring to FIGS. 5 and 6. In FIG. 5, in the beginning, the network camera 1 is always in the standby state (step 1). Then the web server 15 checks whether the client terminal 3 has made an access (step 2) The web server 15 checks whether the request from the Internet 2 is a web page request to make a predetermined request (step 3). The web page to make this request is stored as “index.html” in the display contents generation data storage section 17a of the network camera 1. In case it has determined that the request is not a web page (index.html) request, the web server 15 makes a client request processing (step 1) Details of the client request processing is described later.

In case it has determined that the request is a web page (index.html) request the in step 3, the web server 15 checks whether the network camera 1 can output sound (step 5). In this example, “sound output available” is determined in case a microphone 13A, 13B is connected to the network camera 1 and the sound output on the sound output setting screen 26 (refer to FIG. 4) is set to “available”. Otherwise, “sound output unavailable” is determined. In case “sound output unavailable” is determined (YES), the web server 15 reads the web page describing a sound processing program transmission request from the display contents generation data storage section 17a and transmits the web page to the client terminal 3 (step 6). The description (command) of the sound processing program is <OBJECT classid=”clsid:program#Ver101”codebase=”http://www.Server/program#Ver101>

in case a request for the sound program “program#Ver101” is made to the Server in HTML. Here, the sound processing program is plugged into the browser running on the client terminal 3. The sound processing program is described in a programming language such as Java (R) executable independently of the OS type or PC model. The web server 15 may download a program on the web by way of the automatic download function, instead of installing such a program in the network server 1. In case the web server has determined “sound output unavailable” (NO) in step 5, the web server 15 transmits a web page where a normal image data request not including a sound processing program transmission request is described (step 7).

An access from the client terminal 3 to the network camera 1 will be described. First, an URL used to access the network server 1, for example “http://www.Server/”, is input to the browser of the client terminal 3. Next, the browser makes an inquiry about the global IP address of the network camera 1, for example “192.128.128.0” to the DNS server 4 (refer to FIG. 1). Acquiring the global IP address, the browser accesses the IP address of the network camera 1 in the HTTP protocol (port number 80). To the HTTP header is written the URL of the destination (http://www.Server/). After requesting input of a password to allow a sound-transmitting web page to be transmitted to a client satisfying the password requirement alone, it is possible to allow only a specific user to hear the sound. Or, after requesting input of a password, it is possible not to transmit a sound-transmitting web page to a specific user among the clients satisfying the password requirement. In this case, the specific user does not hear the sound.

Next, the “client request processing” as a transmission control flow of image data will be described referring to FIG. 6. This processing corresponds to step 4 of FIG. 5. This flow starts in case the access from the client is other than a web page (index.html) request. The web server 15 checks whether the request is a sound processing program transmission request (step 11). In case the request is a sound processing program transmission request to be plugged in, the network camera 1 transmits the sound processing program to the client terminal 3 (step 16). In case its is determined that the request is not a sound processing program transmission request in step 11, the web server 15 checks whether the request is an image transmission request (step 12). In case the request is an image transmission request, the web server 15 transmits the image data of an image shot with the camera 5 (step 17). The image transmission request includes various types of requests such as a successive image transmission request or a single-image transmission request. For a successive image transmission request, the network camera 1 keeps transmitting images to the client terminal 3 until the client link is lost or for a predetermined time running.

Then, whether the request is a sound transmission request is checked (step 13) In case the request is a sound transmission request, the controller 9 checks whether a microphone is connected to the network camera 1 (step 14). In case the controller 9 has determined that a microphone is not connected, the network camera 1 gives no response to a request issued from the client. In case the web server 15 has determined that a microphone is connected, the sound output section 11 of the network camera 1 successively transmits the sound data generated based on the sound collected by the microphone, to the client terminal 3 by using a predetermined protocol such as TCP or UDP, until communications with the client terminal 3 are released (for example, in the event of no access or response for a predetermined time) or for a predetermined time (step 15). In case it is determined that the request is not a sound transmission request in step 13, processing to suit the request is carried out.

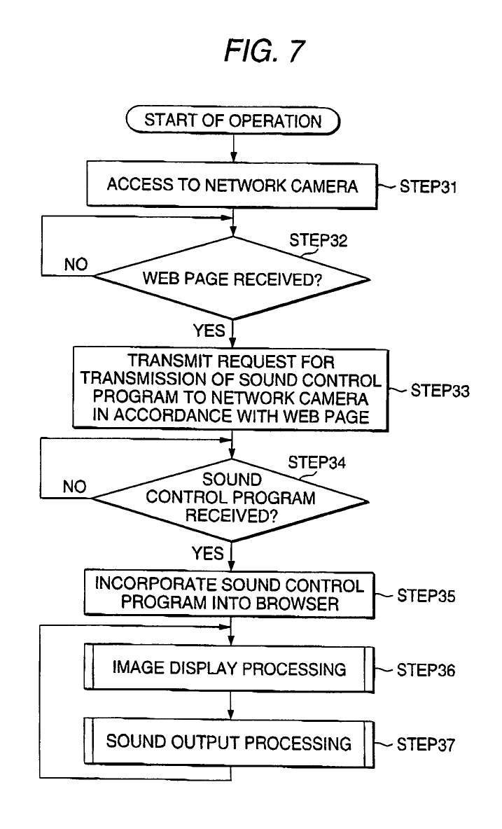

Next, the control flow of the client terminal 3 will be described referring to FIGS. 7 through 9. In FIG. 7, an URL used to access the network server 1 is input to the browser of the client terminal 3 and an access is made to the network camera 1 (step 31). The browser waits for reception of a web page from the network camera 1 (step 32). Receiving the web page, the browser makes a request for transmission of a sound control program to the network camera 1 in accordance with the description in the web page (step 33). The web page describes a request for transmission of a sound control program. Request for transmission of a sound control program is made by transmitting the web page from the client terminal 3 to the network camera 1. After transmission, the client terminal 3 waits for reception of a sound control program (step 34). Receiving the sound control program, the client terminal 3 incorporates the sound control program into the browser (step 35). Then the client terminal 3 repeats the image display processing (step 36) and sound output processing (step 37) mentioned later. In the image display processing, the client makes a request for transmission of image data to the network camera 1. In the sound output processing, the client makes a request for transmission of sound data to the network camera 1.

In case the network camera 1 successively transmits image data or sound data as in a successive image request, an image data transmission request or sound data transmission request by the client terminal 3 need to be issued only once

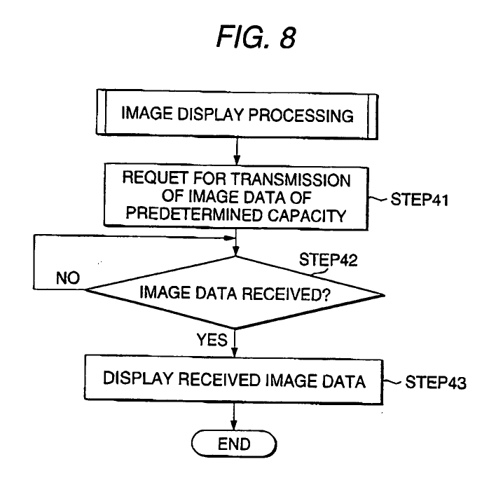

Next, the image display processing will be described. This processing corresponds to step 36 of FIG. 7. In FIG. 8, the client terminal 3 makes an image data transmission request to the network camera 1 in accordance with the description in the web page (step 41). The transmission request preferably includes the information on the resolution and compression ratio of image data. The client terminal 3 waits for reception of image data (step 42). When the xxx has received the image data, the browser of the client terminal 3 displays the received image data in a predetermined position of the display of the client terminal 3 in accordance with the description in the web page (step 43).

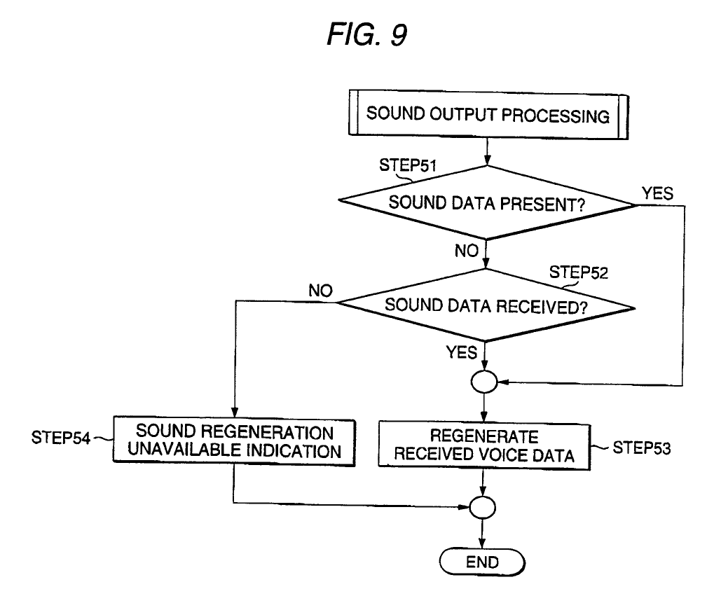

Next, the sound output processing will be described. This processing corresponds to step 37 of FIG. 7. In FIG. 9, the controller (not shown) of the client terminal 3 checks whether sound data is present in the sound buffer (step 51). A memory space for a sound buffer is reserved by the sound processing program. In case sound data is present in the sound buffer, the client terminal 3 regenerates the received sound data and outputs a sound or sound from a sound regenerator such as a loudspeaker (not shown) of the client terminal 3 (step 53). In case sound data is absent in the sound buffer in step 51, the controller of the client terminal 3 checks whether the sound data can be received (step 52). In case the sound data can be received by the client terminal 3, execution proceeds to step 53. In case the sound data cannot be received by the client terminal 3, the sound data cannot be regenerated. The client terminal 3 displays a sound regeneration unavailable indication 20 on the screen display 18 of the client terminal 3 (step 54) The sound regeneration unavailable indication 20 may be any symbol or mark as long as it shows the sound cannot be regenerated. For example, a mark comprising a “X” mark indicating unavailability superimposed on an indication of a loudspeaker displayed in the display area of the screen display 18 when the sound processing program is incorporated in the browser is preferable.

The sound buffer can adjust its capacity to three levels, high, medium and low. By way of the sound processing program and the browser, the volume display 25 of the sound buffer (refer to FIG. 4) is displayed via GUI and operated on-screen. This allows the capacity of the sound buffer to be set and adjusted on the client terminal 3. The three levels, high, medium and low of the sound buffer corresponds to sound data storage for a maximum of 5 seconds, 2 seconds and 0.5 seconds, respectively. Adjustment of the sound buffer capacity appropriately supports the communications state of the Internet 2. Adjustment of the sound buffer is not limited to three levels, high, medium and low but minute adjustment such as 50 levels is possible.

The transfer speed of sound data is 4 kB/second for the ADPCM of 3 kbps but is subject to change a required.

Without a sound buffer, image data from the network camera 1 may reach a client with a delay of several seconds depending on the traffic density on the Internet 2. Variations of in delay cause interruptions in sound. Providing a sound buffer having a fixed capacity cannot appropriately support the communications state of the network. For example, fixing the sound buffer capacity to a large value increases the lag between the screen and the sound as time passes.

In Embodiment 1, a sound buffer is provided on the client terminal 3 and its capacity is made adjustable. This allows sound to be output with an appropriate timing in accordance with the traffic density on the internet 2. It is possible to adjust the size of the buffer for sound storage on the client so that appropriate countermeasure is provided against interruptions in sound.

The sound processing program function has been described from the side of the client terminal 3. Next, the structure of the sound processing program will be described. The sound processing program is described in a programming language such as Java (R) and plugged into the browser of the client terminal 3. The sound processing program functions after being read into the CPU. The ice processing program is a program which expands the browser capability while running standalone or incorporated into a browser program.

The sound processing program in Embodiment 1 comprises function means which performs the following processing in case a microphone 13A, 13B is not connected to the network camera 1 or sound output is disabled. The sound processing program comprises: (1) Transmission means which transmits a web page to make a request for sound data to the network camera 1 via the Internet 2; (2) sound output means which, in case reception means has received sound data in response to sound data requested by the transmission means from the network camera 1, outputs the sound data to a sound regenerator which operates a loudspeaker provided on the client terminal 3; and (3) display control means which, on receiving a response indicating that sound data cannot be transmitted from the network camera 1 after a sound data request, controls the display of the client terminal 3 to display the information that sound output is unavailable.

The sound processing program of Embodiment 1 can make a request for transmission of sound data to the network camera 1 by way of transmission means. The sound processing program can also output sound from the sound regenerator when it has received sound data from the network camera 1. In case the network camera 1 has rejected transmission of sound data, the sound processing program can display the information that sound output is unavailable on the display by way of the display control means.

Further, the sound processing program of Embodiment 1 comprises function means which performs the following processing in case sound data is interrupted for a predetermined time while it is being transmitted: (1) the transmission means; (2) the sound output means; and (3) display control means which controls the display of the client terminal 3 to display the information that sound output is unavailable in case it is determined that sound data is not received for a predetermined time.

In this case, even a client terminal 3 guarded by firewall can detect that sound data is not received for a predetermined time and assume that the microphones 13A, 13B are removed, then provide the-corresponding information on the display.

The sound processing program of Embodiment 1 comprises function means which performs the following processing in case sound data is interrupted for example due to heavy traffic. The sound processing program reserves the memory space for a sound buffer which stores sound data. Further, the sound processing program comprises: (4) sound data control means which temporarily stores sound data into the sound buffer on receiving sound data from the network camera 1. The sound output means, unlike (2) above, reads sound data from the sound buffer and outputs sound from the sound regenerator. The sound processing program further comprises: (5) sound buffer control means which changes the capacity of the sound buffer.

With these functions, capacity of the sound buffer is made adjustable. This allows sound to be output with an appropriate timing in accordance with the traffic density.

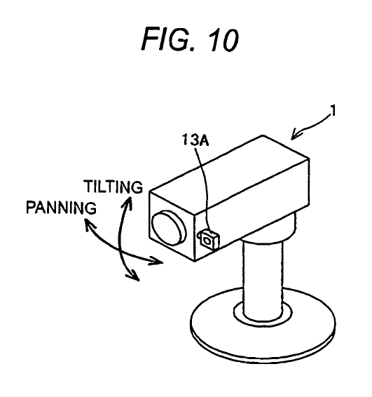

As mentioned hereinabove, in Embodiment 1, only the connection terminals of the external connection microphones 13A, 13B are provided without housing a built-in microphone into the network camera 1. Thus, when wishing not to transmit sound data, the person who has installed the network camera 1 has only to remove the external microphone from the network camera 1 and need not check the setting of sound output from the network camera 1 That is, the connection terminal for the microphone input section provided in a position where it is possible to visually check whether the microphone 13A or 13B is connected. This allows the user to externally recognize that a microphone is not connected at a glance. The position of the connection terminal should be a position where the manager of the network camera 1 can visually check for connection of the microphone 13A, 13B. The position is preferably on the same surface as the lens attaching surface of the camera 5 as shown in FIG. 10, because the direction of capturing the image of a subject of imaging and that of the accompanying sound are aligned.

Use of a microphone with long cord as the external connection microphone 13A, 13B can collect the sound in a desired place while on the move. Providing a plurality of connection terminals on the microphone input section allows stereo data (a stereo sound signal) to be obtained instead of monaural data by connecting the plurality of microphones 13A, 13B to the plurality of connection terminals. This provides real sound on the client terminal 3.

Alternatively, the external connection microphones 13A, 13B which has no cords and are non-flexible may be used as a block and attached to a housing which travels in synchronization with at least the panning (horizontal) direction and/or tilting (vertical) direction of the imaging field. The microphones 13A, 13B moves integrally and synchronously in the direction aligned with the field of view, thereby increasing the presence. Employing the microphones 13A, 13B which has no cords and are non-flexible, which has the size of a thumb, and which comprises a sound input device next to the connection pin allows coordinated operation with the imaging field of the network camera 1.

The network camera 1 may be configured so that to which terminals of the plurality of connection terminals are connected the microphones 13A and 13B can be recognized. This allows the user to recognize from which direction the sound is transmitted, a preferable approach for understanding the imaging/sound collection practices.

The network camera 1 is configured so that control is made not to output sound data when the microphones 13A, 13B are nit connected to the network camera 1. Thus, the quantization noise (white noise) from the sound processor 14 (or A/D converter of the microphone input section 13) is not heard on the client terminal 3. This reduces the unpleasant audio noise. The quantization noise is annoying especially when the volume (on the amplifier) is turned to the maximum. In addition, transmission of meaningless sound data is avoided and the capacity of transmission data is reduced, thereby reducing the traffic data and providing a smooth communications environment.

As mentioned hereinabove, according to the invention, only a connection terminal for external microphones is provided without providing a built-in microphone. Whether a microphone is connected to the connection terminal is detected and transmission of sound data is controlled based on the detection result. This allows transmission from a network camera to be deactivated at a low cost and with ease.

This application is based upon and claims the benefit of priority of Japanese Patent Application No2003-144476 filed on May 5, 2003, the contents of which are incorporated herein by reference in its entirety.

What is claimed:

1. A server apparatus capable of outputting an image data and a sound data via a network in response to a request made by a client terminal, the server apparatus comprising:
a sound input section, to which a sound input device which converts a sound to a sound signal is to connectable;
a sound processor, connected to the sound input section, said sound processor converting the sound signal to a sound data;
a sound output section, which transmits the sound data to the client terminal via the network;
a connection detector, which detects whether the sound input device is connected to the sound input section; and
a controller, which controls transmission of sound data in the sound output section based on the detection result of the connection detector.

2. The server apparatus according to claim 1, wherein, in case that the sound input device is connected, the controller controls the sound output section into an operating state and wherein, in case that the sound input device is not connected, the controller controls the sound output section into a non-operating state.

3. The server apparatus according to claim 1, wherein the server apparatus comprises a storage section which stores setting information on whether to activate the sound output section.

4. The server apparatus according to claim 3, wherein
in case that the setting information stored in the storage section specifies deactivation of the sound output section, the controller makes control so as to deactivate the sound output section despite a sound output request from the client terminal.

5. The server apparatus according to claim 3, wherein
in case that the setting information stored in the storage section specifies activation of the sound output section, the controller transmits to the client terminal the information including a command to request transmission of display information and a sound processing program in response to an access from the client terminal.

6. The server apparatus according to claims 1, wherein:
the sound input section has a plurality of connection terminals for connecting the sound input device and wherein, in case that the controller has determined that the sound input device is connected to at least the two connection terminals, the server apparatus processes the sound data from the sound input device input into a stereo vice signal.

7. A server apparatus capable of outputting an image data and a sound data via a network in response to a request made by a client terminal, the server apparatus comprising:
a sound input section, to which a sound input device which converts a sound to a sound signal is connectable;
a sound processor, connected to the sound input section, the sound processor converting the sound signal to a sound data;
a sound output section, which transmits the sound data to the client terminal via the network;
a connection detector, which detects whether the sound input device is connected to the sound input section; and
a controller, which controls transmission of sound data in the sound output section based on the detection result of the connection detector and which controls the display of a client terminal to provide the information that sound output is unavailable in case that the connection detector has detected that the sound input device is not connected.

8. A server apparatus capable of outputting an image data and a sound data via a network in response to a request made by a client terminal, the server apparatus comprising:
a sound input section to which a sound input device converting a sound to a sound signal is connectable;
a sound processor, connected to the sound input section, the sound processor converting the sound signal to sound data;
a sound output section, which transmits the sound data to the client terminal via said network;
a connection detector, which detects whether the sound input device is connected to the sound input section;
a camera;
an image data generator, which converts an image shot with the camera section to image data;
an HTML generator, which generates a web page described in HTML as data for generating display contents;
an interface, which performs communications control; and
a controller, which transmits the image data to a client terminal via the interface in response to a request from the browser of the external client terminal and controls transmission of sound data in the sound output section based on the detection result of the connection detector.

9. The server apparatus according to claim 8, wherein, in case that the sound input device is connected, the controller controls the sound output section into an operating state and wherein, in case that the sound input device is not connected, the controller controls the sound output section into a non-operating state.

10. The server apparatus according to claim 8, wherein the server apparatus comprises a storage section which stores setting information on whether to activate the sound output section.

11. The server apparatus according to claim 10, wherein
in case that the setting information stored in the storage section specifies deactivation of the sound output section, the controller makes control so as to deactivate the sound output section despite a sound output request from the client terminal.

12. A program functioning on a computer available as a client terminal, the program causing the computer to serve as:
transmission means, which transmits a command to request a sound data to server apparatus via a network;
sound output means, which outputs to a sound regenerator the sound data received from said server apparatus; and
display control means, which controls a display to provide the information that sound output is unavailable on a response that sound data cannot be transmitted from said server apparatus after said command was transmitted.

13. A program functioning on a computer available as a client terminal, the program causing the computer to serve as:
transmission means, which transmits a command to request sound data to server apparatus via a network;
sound output means, which outputs to a sound regenerator the sound data received from said server apparatus; and
display control means, which controls a display to provide the information that sound output is unavailable in case said sound data is not received for a predetermined time.

14. A program functioning on a computer available as a client terminal, the program causing the computer to serve as:
transmission means, which transmits a command to request sound data to server apparatus via a network;
sound data storage means, which stores sound data received from said server apparatus into a sound buffer;
sound output means, which outputs to a sound regenerator the sound data received from said server apparatus; and
sound buffer control means, which changes the capacity of said sound buffer.

15. A data communications system comprising the server apparatus according to any one of claims 1 through 8 and a client terminal on which is installed a program according to any one of claims 12 through 14, said system capable of communicating image data and sound data.

16. A data transmission method whereby server apparatus transmits sound data to a client terminal via a network, the method comprising the steps of:
determining, by the server apparatus, whether a sound input device is connected to the server apparatus;
transmitting, by the server apparatus, sound data in response to a request from said client terminal on determining that the sound input device is connected; and
transmitting, by the server apparatus, a response that the sound input device is not connected to said client terminal on determining that the sound input device is not connected.

17. A data processing method which processes sound data a client terminal has received from server apparatus via a network, the method comprising the steps of:
regenerating the sound data in case said client terminal has received the sound data; and
displaying the information that sound output is unavailable in case the client terminal has not received the sound data for a predetermine time.
